(19) United States
(12) Patent Application Publication
(10) Pub. No.: US 2022/0164878 A1
(43) Pub. Date: May 26, 2022

(54) SYSTEMS AND METHODS FOR AUTOMATED LOAN RECONSIDERATION AND PROVIDING REAL TIME ACCESS TO RECOMMENDATIONS FOR LOAN QUALIFICATION

(71) Applicant: George Demetrios Nakos, Naples, FL (US)

(72) Inventor: George Demetrios Nakos, Naples, FL (US)

(21) Appl. No.: 17/535,903

(22) Filed: Nov. 26, 2021

Related U.S. Application Data
(60) Provisional application No. 63/118,645, filed on Nov. 26, 2020.

(51) Int. Cl. G06Q 40/02

(52) U.S. Cl. CPC G06Q 40/025

(57) ABSTRACT

The present invention relates to systems and methods for automatically reconsidering loan applications when the loan applications are rejected by automated review systems. The systems and methods implement a process that, in response to obtaining a rejection from an automated review system, automatically obtains various information associated with the applicant such as loan application information and credit information, along with guidelines associated with loan qualification requirements, reconsiders the obtained information and generates recommendations for the applicant. Recommendations may comprise at least one of identification of a waiting period until the applicant should reapply for the loan, actions or criteria to satisfy in order to improve applicant's credit status or score, and actions or criteria to satisfy in order to be eligible for the loan for which applicant applied or an identified alternative loan.

### CROSS-REFERENCE TO RELATED APPLICATIONS

This application claims the benefit of U.S. Provisional Application 63/118,645, filed Nov. 26, 2020, titled “SYSTEMS AND METHODS FOR AUTOMATED LOAN RECONSIDERATION,” which is herein incorporated by reference in its entirety.

### BACKGROUND

### Field of the Art

This disclosure relates generally to automated loan application review and more specifically to automatically reconsidering a rejected loan application.

### Discussion of the State of the Art

Many aspects of a home loan application process are automated. A borrower may put requested information into a form and receive an automated approval decision. When the borrower is automatically approved, the system works quite well. However, when the borrower is rejected, a manual review of the application is necessary in order to determine the reasons for the rejection and if the applicant may still qualify for a loan under manual review guidelines. The manual review process may take days or weeks to complete, leaving loan applicants, loan officers, underwriters, real estate agents, and others impacted by the loan qualification status, in the dark with respect to if and when the applicant will qualify for a home loan.

Furthermore, when a loan application is rejected, applicant's may often be unsure why their application was rejected, and what would need to change in order for them to qualify. This is due, at least in part, to automated review systems operating in black box fashion and simply outputting positive or negative decisions, while there could be a variety of underlying reasons for the rejection such as insufficient credit score, insufficient income or assets, too much debt. Moreover, credit score can be affected at a more granular level, including negative credit components such as late payments, and positive credit components such as number and age of open tradelines, while other decision criteria may be based on a combination of factors such as debt to income ratio. Ultimately, a simple negative outcome from an automated application review fails to provide sufficient insight as to which application component or combination of components are deficient and thus leading to the rejection decision.

What is needed is an automated system to reconsider rejected applications, apply manual underwriting guidelines in an automated manner, and provide interested parties with real-time access to the status of the loan reconsideration, and guidance and recommendations for achieving a qualifying status or loan approval decision.

### SUMMARY

The present invention utilizes systems and/or methods for automatically reconsidering a rejected loan application. In an example method, automated decision data may be obtained. In the example method, Uniform Residential Loan Application (URLA) data may be retrieved. In the example method, credit data may be retrieved. In the example method, the data may be standardized. In the example method, a decision may be generated based on the standardized data and guidelines. In the example method, a determination may be made whether the generated decision comprises a positive outcome. If it is determined that the generated decision comprises a positive outcome, then real-time access to the generated decision may be enabled. If it is determined that the generated decision does not comprise a positive outcome, then recommendations may be generated.

One benefit of the present invention is that loans may be reconsidered and/or corrective measures may be suggested without human assistance. This reduces the effort it takes to process a loan application.

The present invention may use a merged credit report to determine a credit portion of a loan decision. The present invention may use one or more unmerged credit reports to correct the merged credit report. The present invention may use the unmerged credit reports to make suggestions about how to update and correct the merged credit report. The present invention may compare previous (historical) merged and unmerged credit reports to point out and analyze changes. The present invention may use unmerged credit files in addition to merged credit files to produce findings recommendations and to correct merged credit files.

The present invention may also be used to analyze and downgrade an AUS approval to require manual underwriting.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for automatically reconsidering a loan application in accordance with an exemplary embodiment of the invention.

FIG. 2 illustrates an implementation of a decider system in accordance with an embodiment of the invention.

FIG. 3 illustrates a flowchart for automatically reconsidering a loan application in accordance with an exemplary embodiment of the present invention.

FIG. 4 illustrates an exemplary computing device that supports an embodiment of the inventive disclosure.

FIG. 5 illustrates an exemplary standalone computing system that supports an embodiment of the inventive disclosure.

FIG. 6 illustrates one embodiment of a computing architecture that supports an embodiment of the inventive disclosure.

FIG. 7 illustrates an exemplary overview of a computer system that supports an embodiment of the inventive disclosure.

### DETAILED DESCRIPTION

The inventive systems and methods (hereinafter sometimes referred to more simply as “system” or “method”) described herein significantly reduce the time and effort it takes to get thorough review of a loan application. An applicant may apply for a home loan. The home loan may go through an automated review. The automated review may determine that the applicant should not be approved for the loan. Automated reconsideration of the automated review may be triggered. Automated reconsideration may be performed by a manual automated underwriting system (MAUS) which applies manual underwriting guidelines in an automated manner. Automated reconsideration of the automated review may comprise receiving data about the automated review, credit data associated with the applicant, and/or Uniform Residential Loan Application (URLA) data associated with the applicant. If automated reconsideration reveals that the loan application should be approved, then the applicant may receive notification of the loan application approval. If automated reconsideration reveals that the loan application should be rejected, then the applicant may receive recommendations for future approval of the loan application. For example, a determination may be made that an item negatively affecting a credit score may drop off of the credit score in 3 months. The recommendations may comprise paying all bills on time for the next 3 months and then reapplying for the loan application.

In one embodiment, the process may reference a merged credit report (for example, a trimerge report) and/or individual credit reports that may be issued by individual reporting agencies or bureaus. In some specific embodiments, the process may identify differences between data in a merged report against data in the individual reports. In one embodiment, the merged report and/or one or more individual reports may be used to perform the automated and manual underwriting process described herein. In some instances, one or more the reports may be corrected or updated based on the data in the other reports.

In one embodiment, the URLA and merged credit report may be processed for automated underwriting. If the automated underwriting process results in a “refer” outcome, then the data may be processed under the manual underwriting process described herein. If the manual underwriting process results in a decline, then the process may compute the next day and/or time frame when the applicant's application may be approved on the basis of some negative credit history rolling off the one or more credit reports. In one embodiment, the process outputs a defined date, and/or a waiting period. For example, if the MAUS process establishes a minimum or maximum waiting period until the loan may be approved, such may be output and made available to users such as the applicant(s), loan officers and underwriters.

More specifically, in one embodiment, the process may analyze the credit lines that may be noted in the one or more credit report. Each tradeline and/or credit line may have its own look-back period and weighting methodology, which may affect how and/or how many negative or late payments may affect the applicant's credit for automatic and/or manual underwriting processes. For example, revolving credit typically has a 12 month look back period, installment payments typically have a 24 month look back period, rent/mortgage has a 12 month lookback period, and bankruptcy/foreclosure typically has a 24 month lookback period. Another way to conceptualize the look back period is as a waiting period for when the loan can be approved into the future assuming that negative credit is not newly accumulated.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Conceptual Architecture

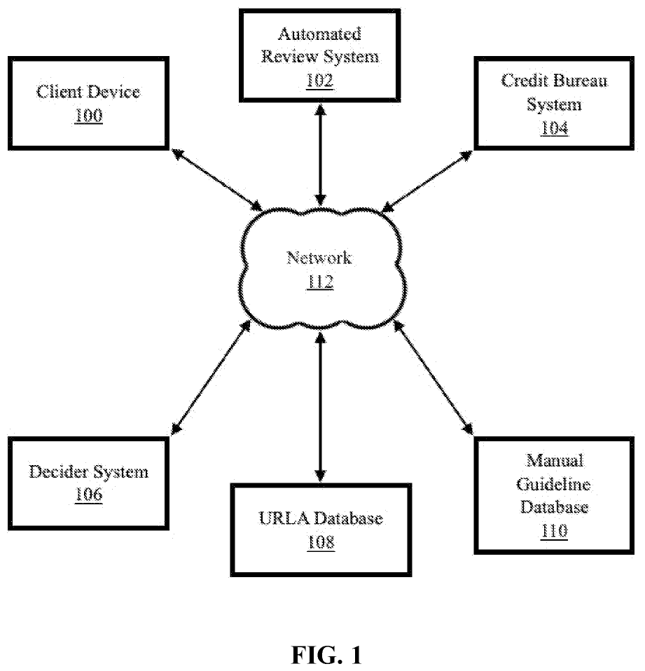

FIG. 1 illustrates a system for automatically reconsidering a loan application with an exemplary embodiment of the invention. The system may comprise a client device 100, an automated review system 102, a credit bureau system 104, a decider system 106, Uniform Residential Loan Application (URLA) database 108, a manual guideline database 110, and a network 112. The various computing devices described herein are exemplary and for illustration purposes only. The system may be reorganized, consolidated, comprise a plurality of one or more of the devices and systems depicted, and comprise additional devices and systems not depicted, as understood by a person of ordinary skill in the art, to perform the same tasks on one or more other servers or computing devices without departing from the scope of the invention.

The client device 100 may be in communication with one or more of the automated review system 102, the credit bureau system 104, the decider system 106, the URLA database 108, and/or the manual guideline database 110 via the network 112. The client device 100 (herein referred to as user input device, user device, or client device) may include, generally, a computer or computing device including functionality for communicating (e.g., remotely) over the network 112. Data may be collected from client devices 100, and data requests may be initiated from each client device 100. Client device(s) 100 may be a server, a desktop computer, a laptop computer, personal digital assistant (PDA), an in- or out-of-car navigation system, a smart phone or other cellular or mobile phone, or mobile gaming device, among other suitable computing devices. Client devices 100 may execute one or more client applications, such as a web browser (e.g., Microsoft Windows Internet Explorer, Mozilla Firefox, Apple Safari, Google Chrome, and Opera, etc.), or a dedicated application to submit user data, or to make prediction queries over the network 112. Each of the devices, systems, and databases may be associated with a hardware and/or software platform unique to that device, system or database.

In particular embodiments, each client device 100 may be an electronic device including hardware, software, or embedded logic components or a combination of two or more such components and capable of carrying out the appropriate functions implemented or supported by the client device 100. For example and without limitation, client device 100 may be a desktop computer system, a notebook computer system, a netbook computer system, a handheld electronic device, or a mobile telephone. The present disclosure contemplates any user device as the client device 100. The client device 100 may enable a network user at the client device 100 to access network 112. The client device 100 may enable its user to communicate with other users at other client devices.

The client device 100 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. The client device 100 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the client device 100 one or more Hyper Text Markup Language (HTML) files responsive to the HTTP request. The client device 100 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The client device 100 may also include an application that is loaded onto the client device 100. The application obtains data from the network 112 and displays it to the user within the application interface.

This disclosure contemplates any suitable number of client devices 100, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

The automated review system 102 may generate automated decision data related to a home loan application. The generated automated decision data may comprise loan qualification information associated with a home loan application. The generated automated decision data may comprise an indication of a rejection of the home loan application, which may be at least one of a credit based rejection and a loan structure based rejection. The automated review system 102 may be associated with a government agency. The automated review system 102 may be associated with the Federal Housing Administration (FHA). The automated review system 102 may be associated with the United States Department of Agriculture (USDA). The automated review system 102 may be associated with the Veterans Administration or U.S. Department of Veterans Affairs (VA).

The automated review system 102 may be associated with a quasi-government agency. The automated review system 102 may be associated with Fannie Mae (FNMA). The automated review system 102 may be associated with Freddie Mac (FHLMC). The automated review system 102 may be associated with an Automated Underwriting System (AUS). At least a portion of the automated decision data may comprise data in Mortgage Industry Standards Maintenance Organization (MISMO) format.

The credit bureau system 104 may generate credit data related to a home loan application. The credit data may comprise a credit score of an applicant of the home loan application. The credit data may comprise positive credit elements such as number of open tradelines, existing credit limit, and age of open tradelines. The credit data may comprise negative credit elements such as collections, charge offs, bankruptcies, foreclosures and other public records. The credit bureau system 104 may be associated with Experian. The credit bureau system 104 may be associated with Equifax. The credit bureau system 104 may be associated with TransUnion.

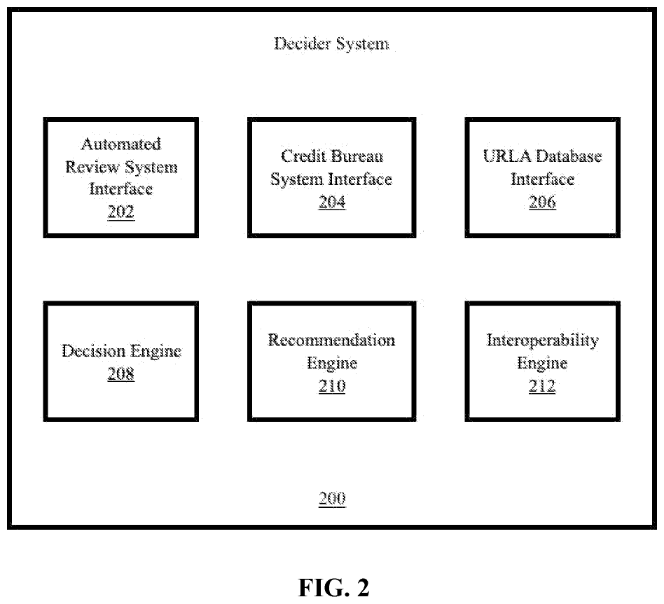

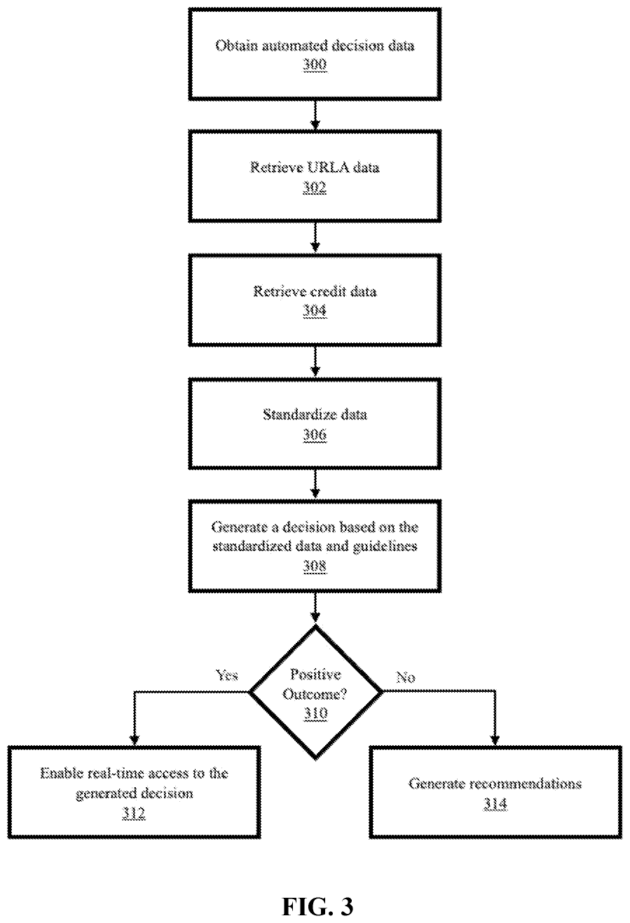

The decider system 106 may reconsider a loan application rejected by the automated review system 102. The decider system 106 may transmit a notification of approval to the client device 100 via the network 112, in the event that a determination that approval is appropriate based on reconsideration of the loan application. The decider system 106 may generate recommendations for future loan approval in the event that a determination that rejection is appropriate based on reconsideration of the loan application. The decider system 106 may transmit an indication of the generated recommendations to the client device 100 via the network 112. The decider system 106 may automatically obtain, in response to a rejection indication obtained from the automated review system 102, loan application information from the URLA system, credit information from the credit bureau system 104, and guideline information from the manual guidelines database 110. The decider system 106 will be discussed in greater detail in reference to FIGS. 2-3. Although depicted here as a separate system, the inventive concepts around the decider system 106 may be implemented in other way such as via incorporation into or via modification of the automated review system 102 such that the automated review system 102 performs a first analysis according to first criteria or guidelines and upon determination that an application is not satisfactory for approval, performs the processing associated with the decider system 106 in order to provide the same output as the decider system 106 as discussed in more detail below.

The URLA database 108 may store URLA data. At least a portion of the URLA data may be the same as URLA data associated with the automated decision data generated by the automated review system 102 (“original URLA data”). At least a portion of the URLA data may be varied from the original URLA data. At least a portion of the URLA data may comprise data in MISMO format. At least a portion of the URLA data may comprise data derived from email messages, social media messages, short message service (SMS) messages, the like, and/or any combination of the foregoing. At least a portion of the URLA data may comprise data received from a conditions checklist. The conditions checklist may be generated based on the data derived from email messages, social media messages, SMS messages, the like, and/or any combination of the foregoing. The conditions checklist may comprise a questionnaire data, actual data in Extensible Markup Language (XML) format updated in real-time, a stage of a loan, the like, and/or any combination of the foregoing. URLA data may comprise at least one of income, assets, liabilities, debt to income ratio, loan amount, loan program, expected down money, and expected loan-to-value.

The manual guideline database 110 may store guidelines. The guidelines may be used to determine eligibility for a particular loan. The guidelines may be associated with FHA guidelines. The guidelines may be associated with USDA guidelines. The guidelines may be associated with VA guidelines. The guidelines may be associated with FNMA guidelines. The guidelines may be associated with FHLMC guidelines. The guidelines may be credit based guidelines. The guidelines may be loan based guidelines.

Credit based guidelines may comprise negative credit requirements and/or positive credit requirements. For example, negative credit requirements may comprise no late payments in the last 12 months for any tradeline and/or no more than two late payments during the prior period ranging from 12 months to 24 months. Negative credit requirements may comprise open collections items, charge offs, bankruptcies within a threshold timeframe, foreclosures within a threshold timeframe, and other public records negatively impacting credit. Positive credit requirements may comprise a minimum number of open tradelines which have been in place for a minimum duration of time. For example, positive credit requirements may comprise at least three open tradelines which have been in place for at least 12 months. Positive credit requirements may comprise verification of rent payment history or other recurring expenses paid on time (e.g. monthly bill payments).

Loan based guidelines may comprise down money requirements, minimum credit score, income limits, a minimum income threshold, minimum employment duration, minimum asset threshold, debt to income ratio requirements, loan to value ratio requirements, appraisal requirements, property condition requirements, maximum loan limits, loan program eligibility or entitlement, etc.

The network 112 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 112 is an intranet, an extranet, a virtual private network (VPN), a local area network (LAN), a wireless LAN (WLAN), a wide area network (WAN), a metropolitan area network (MAN), a portion of the Internet, or another network 112 or a combination of two or more such networks 112. One or more links connect the systems and databases described herein to the network 112. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 112, and any suitable link for connecting the various systems and databases described herein.

The network 112 connects the various systems and computing devices described or referenced herein. In particular embodiments, network 112 is an intranet, an extranet, a virtual private network (VPN), a local area network (LAN), a wireless LAN (WLAN), a wide area network (WAN), a metropolitan area network (MAN), a portion of the Internet, or another network or a combination of two or more such networks 112. The present disclosure contemplates any suitable network 112.

One or more links couple one or more systems, engines or devices to the network 112. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 112.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

In one aspect, the system may comprise a loan origination system configured to obtain applicant loan information and convert the information into the necessary variables and format for use in the automated review system 102. For example, the loan origination system may be configured to obtain responses to a questionnaire or responses associated with completion of a form, convert the obtained responses into appropriate output such as by performing calculations based on the obtained responses or converting the responses into the necessary XML format to be uploaded into the AUS.

### Loan Application Reconsideration Software Suite

FIG. 2 illustrates an implementation of a decider system 200 in accordance with an embodiment of the invention. The decider system 200 may be or comprise the decider system 106 in FIG. 1. The decider system 200 may comprise an automated review system interface 202, a credit bureau system interface 204, a Uniform Residential Loan Application (URLA) database interface 206, a decision engine 208, a recommendation engine 210, and/or an interoperability engine 212. Other systems and databases may be used, as would be readily understood by a person of ordinary skill in the art, without departing from the scope of the invention.

The automated review system interface 202 may receive automated decision data from the automated review system 102 in FIG. 1 via the network 112 in FIG. 1. The automated review system interface 202 may accept automated decision data in a protocol and/or format suitable for transmission via the network 112. The automated review system interface 202 may convert the automated decision data into a protocol and/or format suitable for processing by the decision engine 208. The automated review system interface 202 may convert the automated decision data into a protocol and/or format suitable for processing by the recommendation engine 210. The automated review system interface 202 may convert the automated decision data into a protocol and/or format suitable for processing by the interoperability engine 212.

The automated decision data may comprise a rejection of a loan application. The automated decision data may comprise a rejection of a home loan application. The automated decision data may comprise a rejection from a government agency of a home loan application. The automated decision data may comprise a rejection of a Federal Housing Administration (FHA) backed home loan application. The automated decision data may comprise a rejection of a United States Department of Agriculture (USDA) backed home loan application. The automated decision data may comprise a rejection of a Veteran's Administration or U.S. Department of Veterans Affairs (VA) backed home loan application. The automated decision data may comprise a rejection from a quasi-government agency of a home loan application. The automated decision data may comprise a rejection from Fannie Mae (FNMA) of a home loan application. The automated decision data may be a rejection from Freddie Mac (FHLMC) of a home loan application. The automated decision data may be associated with an Automated Underwriting System (AUS). At least a portion of the automated decision data may comprise data in Mortgage Industry Standards Maintenance Organization (MISMO) format.

The credit bureau system interface 204 may receive credit data from the credit bureau system 104 in FIG. 1 via the network 112 in FIG. 1. The credit bureau system interface 204 may accept credit data in a protocol and/or format suitable for transmission via the network 112. The credit bureau system interface 204 may convert the credit data into a protocol and/or format suitable for processing by the decision engine 208. The credit bureau system interface 204 may convert the credit data into a protocol and/or format suitable for processing by the recommendation engine 210. The credit bureau system interface 204 may convert the credit data into a protocol and/or format suitable for processing by the interoperability engine 212. The credit data may comprise a credit score. The credit data may comprise positive credit elements such as number of open tradelines, existing credit limit, and age of open tradelines. The credit data may comprise negative credit elements such as collections, charge offs, bankruptcies, foreclosures and other public records. The credit data may be associated with Experian. The credit data may be associated with Equifax. The credit data may be associated with TransUnion.

The URLA database interface 206 may receive URLA data from the URLA database 108 in FIG. 1 via the network 112 in FIG. 1. The URLA database interface 206 may accept URLA data in a protocol and/or format suitable for transmission via the network 112. The URLA database interface 206 may convert the URLA data into a protocol and/or format suitable for processing by the decision engine 208. The URLA database interface 206 may convert the URLA data into a protocol and/or format suitable for processing by the recommendation engine 210. The URLA database interface 206 may convert the URLA data into a protocol and/or format suitable for processing by the interoperability engine 212.

At least a portion of the URLA data may be the same as URLA data associated with the automated decision data (“original URLA data”). At least a portion of the URLA data may be varied from the original URLA data. At least a portion of the URLA data may comprise data in MISMO format. At least a portion of the URLA data may comprise data derived from email messages, social media messages, short message service (SMS) messages, the like, and/or any combination of the foregoing. At least a portion of the URLA data may comprise data received from a conditions checklist. The conditions checklist may be generated based on the data derived from email messages, social media messages, SMS messages, the like, and/or any combination of the foregoing. The conditions checklist may comprise a questionnaire data, actual data in Extensible Markup Language (XML) format updated in real-time, a stage of a loan, the like, and/or any combination of the foregoing. URLA data may comprise at least one of income, assets, liabilities, debt to income ratio, loan amount, loan program, expected down money, and expected loan-to-value.

The decision engine 208 may generate a decision based on standardized data and guidelines. The standardized data may comprise data received from the interoperability engine 212. The guidelines may comprise data received from the manual guideline database 110 in FIG. 1 via the network 112 in FIG. 1. The guidelines may be associated with FHA guidelines. The guidelines may be associated with USDA guidelines. The guidelines may be associated with VA guidelines. The guidelines may be associated with FNMA guidelines. The guidelines may be associated with FHLMC guidelines. The decision may relate to a pending loan application. A positive outcome associated with the decision may comprise approval of the loan application. A negative outcome associated with the decision may comprise rejection of the loan application. An indication of the decision may be transmitted to one or more client device(s) 100 in FIG. 1 via the network 112 in FIG. 1 and displayed in real-time via a graphical user interface (GUI) associated with the client device(s) 100.

The decision engine 208 may be configured such that when the decision results in a negative outcome, the decision engine 208 automatically acquires updated standardized data and reevaluates the decision periodically. For example, if decision engine 208 determines that an applicant is not approved for a loan based on currently available information, the decision engine may obtain up to date information, such as credit data, at recurring time intervals (e.g. monthly) in order to reevaluate and monitor an applicant's loan qualification status. In one aspect, the time interval for reevaluating loan qualification status is based on the recommendations from the recommendation engine 210 as discussed below. For example, if the recommendations determine a waiting period for reapplying, the decision engine 208 may automatically reevaluate the decision after that waiting period has lapsed. The decision engine 208 may be configured to provide up to date information associated with these recurring reevaluations of loan qualification status to at least one user such as the applicant, loan officer, etc. so that the users have access to up to date real-time loan qualification information and can take appropriate action if applicant appears to be moving away from a positive qualification status, recalculate if/when an applicant is expected to qualify, and/or issue an approval notification should the reevaluation indicate applicant is now qualified for a loan. The decision engine 208 may be configured to obtain recommendations generated by the recommendation engine 210 (discussed below) and provide reminders or notifications based on the recommendations. For example, decision engine 208 may be configured to notify an applicant or other user that a waiting period has passed and the loan application should be reprocessed. The decision engine 208 may be configured to obtain recommendations generated by the recommendation engine 210 (discussed below) and automatically perform actions based on the recommendations. For example, decision engine 208 may be configured to automatically resubmit or reprocess a loan application after a waiting period has passed or after other criteria, such as those discussed below, have been satisfied.

The recommendation engine 210 may generate recommendations in response to the decision engine 208 generating a decision comprising a negative outcome. The generated recommendations may be generated automatically in response to a decision from the decision engine 210. The generated recommendations may comprise criteria and/or actions for improving a credit score. The generated recommendations may comprise a waiting period before reapplying for a loan. The generated recommendations may comprise future conditional loan approval. The generated recommendations may comprise recommendations for conforming to one or more guidelines. An indication of the generated recommendations may be transmitted to the client device 100 in FIG. 1 via the network 112 in FIG. 1.

Generated recommendations of criteria and/or actions for improving a credit score may comprise criteria and/or actions to reduce or eliminate the effects of negative credit. Exemplary criteria and/or actions comprise instructions to pay off or reduce existing debt (which may be accompanied with a deadline by which the debt should be eliminated or reduced below a threshold amount), a period of time over which late payments should be avoided, a period of time over which debt should not increase, a period of time over which credit inquiries should be avoided. Generated recommendations of criteria and/or actions for improving a credit score may comprise criteria and/or actions to add positive credit components or increase the effects of existing positive credit. For example, recommendations or criteria associated positive credit components may comprise increasing the age of open tradelines (in particular to hit a threshold or target age such as having been open for at least 12 months), opening additional tradeline(s) (in particular to reach a minimum threshold number of tradelines such as three), a deadline by which applicant should have a threshold number of open tradelines each with an age exceeding a threshold amount such as those described above, increase credit limit to meet or exceed a threshold amount, reduce the percentage of used revolving credit below threshold amount, and increase the percentage of unused revolving credit above a threshold amount, any of which may be coupled with timeframe or deadline.

With respect to generated recommendations of a waiting period before reapplying for a loan, the recommendation engine 210 is configured to automatically compute an estimated waiting time after which the applicant is expected to qualify for the loan. The waiting time may be computed based on how much time must pass until at least one negative credit component will no longer affect, or have a reduced effect on the applicant's credit status or score (e.g. a negative credit component “falls off” the credit report, no late payments over the waiting time, debt decreased to a threshold level by the end of the waiting period, etc.). The waiting time may be computed based on how much time must pass until at least one positive credit component will have greater impact on the applicant's credit status or score (e.g. age of credit history such as tradelines open for long enough duration such as 12 or more months, amount of revolving credit being used is below a threshold, mixture of open credit accounts, etc.). The waiting period may be computed based on how much time is needed for a combination of negative and positive credit components to collectively bring an applicant's credit score above a threshold.

With respect to generated recommendations for conforming to one or more guidelines, recommendations may comprise requirements associated with one or more loan programs such as down money requirements, income limits, minimum credit score, debt to income ratio requirements, loan to value ratio requirements, appraisal requirements, property condition requirements, maximum loan limits, loan program eligibility or entitlement, etc. Generated recommendations for conforming to one or more guidelines may comprise recommending an alternative loan program and/or loan structure than that which was applied for or the loan application information contained in the URLA data. Generated recommendations for conforming to one or more guidelines may comprise recommendations based on loan stage (e.g. pre-qualification, pre-approval, loan processing, underwriting, etc.).

With respect to generated recommendations of future conditional loan approval a conditional loan approval may be generated comprising conditions that must be satisfied along with deadlines or timeframes for satisfying the conditions such that applicant would then qualify for the loan. The future conditional loan approval may be related to one or more of the above discussed credit and loan guidelines. For example, the conditional loan approval may be contingent on increasing credit score, reducing debt/liabilities, decreasing debt to income ratio, increasing assets (e.g. down money), avoiding taking on additional debt, continue making on time payments (bills, loans, rent, etc), decreasing loan to value, satisfying loan program criteria, where any of these optionally being associated with a deadline or timeframe to satisfy the condition.

The interoperability engine 212 may standardize data from the automated review system interface 202, the credit bureau system interface 204, and/or the URLA database interface 206. Data obtained from each of the devices, systems, and databases may be in a standardized or non-standardized format which may be dependent on the hardware and/or software platform associated with each device, system and database. Standardizing the data may comprise making similar fields conform to a similar format (e.g., labelling format, Extensible Markup Language (XML) structure, JavaScript Object Notation (JSON) structure, etc.). For example, income information received from the automated review system interface 202, income information received from the credit bureau system interface 204, and/or income information received from the URLA database interface 206 may be put in a standardized format for income information.

Upon automatic generation of the recommendations in real-time, the decider system 200 is configured to provide, in real-time, at least one of up to date loan qualification information (e.g. decisions from the decision engine), recommendations, credit information, loan application information and guideline information in an as received format or in a standardized format (e.g. based on standardization conversions performed by the interoperability engine 212.

### Processes for Reconsidering a Loan Application

FIG. 3 illustrates a flowchart for automatically reconsidering a loan application in accordance with an exemplary embodiment of the present invention.

At 300, automated decision data may be obtained. For example, the decider system 106 in FIG. 1 may obtain automated decision data from the automated review system 102 in FIG. 1 via the network 112 in FIG. 1. The decider 200 in FIG. 2 may obtain automated decision data via the automated review system interface 202 in FIG. 2. The automated decision data may comprise a rejection of a loan application. The automated decision data may comprise a rejection of a home loan application. The automated decision data may comprise a rejection from a government agency of a home loan application. The automated decision data may comprise a rejection of a Federal Housing Administration (FHA) backed home loan application. The automated decision data may comprise a rejection of a United States Department of Agriculture (USDA) backed home loan application. The automated decision data may comprise a rejection of a Veteran's Administration or U.S. Department of Veterans Affairs (VA) backed home loan application. The automated decision data may comprise a rejection from a quasi-government agency of a home loan application. The automated decision data may comprise a rejection from Fannie Mae (FNMA) of a home loan application. The automated decision data may be a rejection from Freddie Mac (FHLMC) of a home loan application. The automated decision data may be associated with an Automated Underwriting System (AUS). At least a portion of the automated decision data may comprise data in Mortgage Industry Standards Maintenance Organization (MISMO) format.

At 302, Uniform Residential Loan Application (URLA) data may be retrieved. For example, the decider system 106 in FIG. 1 may retrieve URLA data from the URLA database 108 in FIG. 1 via the network 112 in FIG. 1. The decider 200 in FIG. 2 may retrieve URLA data via the URLA database interface 206 in FIG. 2. At least a portion of the URLA data may be the same as URLA data associated with the automated decision data (“original URLA data”). At least a portion of the URLA data may be varied from the original URLA data. At least a portion of the URLA data may comprise data in MISMO format. At least a portion of the URLA data may comprise data derived from email messages, social media messages, short message service (SMS) messages, the like, and/or any combination of the foregoing. At least a portion of the URLA data may comprise data received from a conditions checklist. The conditions checklist may be generated based on the data derived from email messages, social media messages, SMS messages, the like, and/or any combination of the foregoing. The conditions checklist may comprise a questionnaire data, actual data in Extensible Markup Language (XML) format updated in real-time, a stage of a loan, the like, and/or any combination of the foregoing.

At 302, the process may compare the data in the URLA to the data in the AUS. If differences are detected, then they may be highlighted and placed in a manual automated underwriting system MAUS system queue. If no differences are detected, then the process may continue to step 304. Similarly, at 304 and/or 306, the data obtained and/or standardized from the received credit data may be compared to the data in the AUS. Any differences detected in the AUS data and the credit card data may be highlighted and/or the application may be placed in the MAUS system queue. If no differences are detected, then the process may continue as described herein.

At 304, credit data may be retrieved. For example, the decider system 106 in FIG. 1 may retrieve credit data from the credit bureau system 104 in FIG. 1 via the network 112 in FIG. 1. The decider 200 in FIG. 2 may retrieve credit data via the credit bureau system interface 204 in FIG. 2. The credit data may comprise a credit score. The credit data may be associated with Experian. The credit data may be associated with Equifax. The credit data may be associated with TransUnion.

At 306, data may be standardized. For example, the decider system 106 in FIG. 1 may standardize the obtained automated decision data, the retrieved URLA data, and/or the retrieved credit data. The decider 200 in FIG. 2 may use the interoperability engine 212 in FIG. 2 to standardize data. Standardizing the data may comprise making similar fields conform to a similar format (e.g., labelling format, Extensible Markup Language (XML) structure, JavaScript Object Notation (JSON) structure, etc.). For example, income information associated with the obtained automated decision data, income information associated with the retrieved URLA data, and/or income information associated with retrieved credit data may be put in a standardized format for income information.

At 308, a decision may be generated based on the standardized data and guidelines. For example, the decider system 106 in FIG. 1 may generate a decision based on the standardized data and guidelines. The guidelines may be received from the manual guideline database 110 in FIG. 1. The decider 200 in FIG. 2 may use the decision engine 208 in FIG. 2 to generate a decision based on the standardized data and guidelines. The guidelines may be associated with FHA guidelines. The guidelines may be associated with USDA guidelines. The guidelines may be associated with VA guidelines. The guidelines may be associated with FNMA guidelines. The guidelines may be associated with FHLMC guidelines.

At 310, a determination may be made whether the generated decision comprises a positive outcome. For example, the decider system 106 in FIG. 1 may determine if the generated decision comprises a positive outcome. If the generated decision is determined to comprise a positive outcome, the method may advance to 312. If the generated decision is not determined to comprise a positive outcome, the method may advance to 314.

At 312, real-time access to the generated decision may be enabled. For example, the decider system 106 in FIG. 1 may enable real-time access to the generated decision to the client device 100 in FIG. 1 via the network 122 in FIG. 1. The generated decision may comprise instructions for obtaining an approval of a loan application. The generated decision may comprise loan terms and/or details. The generated decision may comprise instructions for loan acceptance.

At 314, recommendations may be generated. For example, the decider system 106 in FIG. 1 may generate recommendations. The decider 200 in FIG. 2 may use the recommendation engine 210 in FIG. 2 to generate recommendations. The generated recommendations may comprise criteria and/or actions for improving a credit score. The generated recommendations may comprise a waiting period before reapplying for a loan. The generated recommendations may comprise future conditional loan approval. The generated recommendations may comprise recommendations for conforming to one or more guidelines. The generated recommendations, actions, waiting period, future conditional loan approval, and recommendations for conforming to guidelines may comprise those as discussed above in association with the recommendation engine 210 of FIG. 2.

In one embodiment, the same process may be used to analyze and downgrade an AUS approval to require manual underwriting by following steps 304 to 312 or 314.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

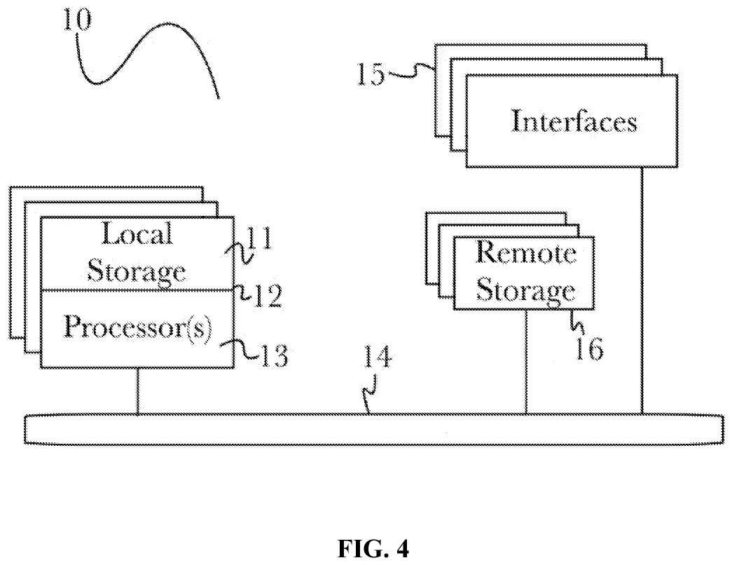

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

The computing device 10 may be and/or comprise the decider system 106 in FIG. 1 or decider system 200 in FIG. 2.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

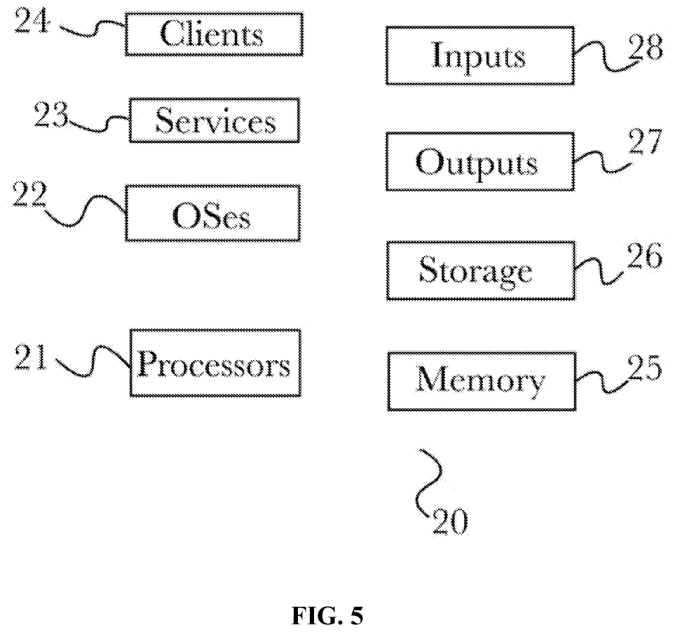

In some embodiments, systems may be implemented on a standalone computing system. Referring now to FIG. 5 above, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

The system 20 may be and/or comprise the decider system 106 in FIG. 1 or decider system 200 in FIG. 2.

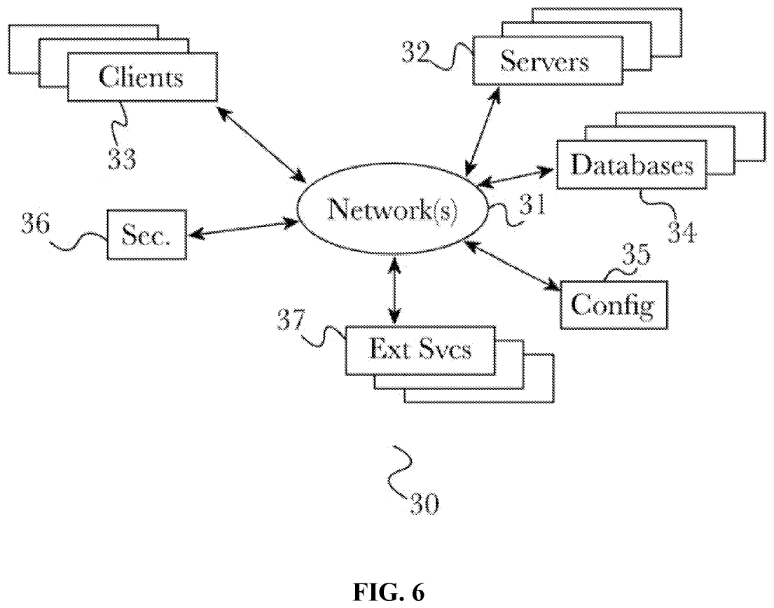

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

The one or more of the server(s) 32 may be and/or comprise the decider system 106 in FIG. 1 or decider system 200 in FIG. 2.

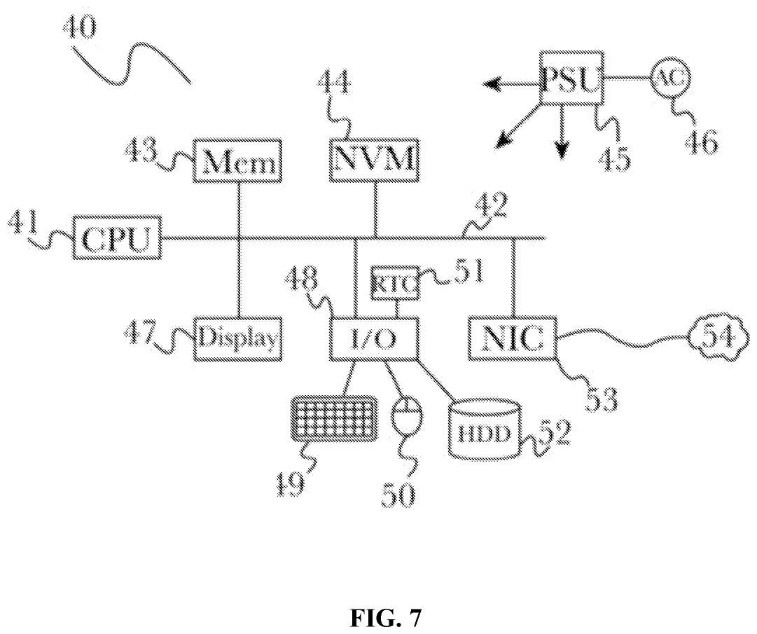

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

The computer system 40 may be and/or comprise the decider system 106 in FIG. 1 or decider system 200 in FIG. 2.

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for providing users with real time access to loan qualification information, the computer implemented method comprising:
providing remote access to users over a network so any one of the users can initiate a loan qualification status check in real time through a graphical user interface;
obtaining, from an automated review system, loan qualification status information associated with an applicant, the automated review system associated with a hardware and/or software platform, the loan qualification status information indicating the applicant does not qualify for a loan;
automatically obtaining, from a universal residential loan application system and in response to the obtained loan qualification status information, loan application information associated with the applicant, the universal loan application system associated with a hardware and/or software platform;
automatically obtaining, from a credit report system and in response to the obtained loan qualification status information, credit information associated with the applicant, the credit system associated with a hardware and/or software platform;
wherein at least one of the loan qualification status information, loan application information and credit information is obtained in at least one of a standardized and non-standardized format based on the hardware and/or software platform associated with the corresponding system from which the information was obtained;
converting, by a processor, at least one of the loan qualification status information, loan application information, and credit information to a standardized format;
automatically computing, by a processor, at least one of an expected waiting time and applicant recommendations, the computing based on the standardized format of the loan qualification status information, loan application information, and credit information; and
providing at least one of the loan qualification status information in the standardized format, loan application information in the standardized format, credit information in the standardized format, expected waiting time and applicant recommendations, via remote access to users over a network, wherein each user is enabled to access up-to-date loan qualification information.

2. The computer implemented method according to claim 1, wherein the automated review system comprises an automated underwriting system.

3. The computer implemented method according to claim 1, wherein the loan qualification information indicating the applicant does not qualify for a loan comprises at least one of a credit based decision and a loan structure based decision.

4. The computer implemented method according to claim 1, wherein the loan application information comprises at least one of income, assets, liabilities, debt to income ratio, loan amount, loan program, expected down money, and expected loan-to-value.

5. The computer implemented method according to claim 1, wherein the credit report system comprises at least one credit bureau system.

6. The computer implemented method according to claim 1, wherein the credit information comprises at least one of a credit score, positive credit elements, and negative credit elements.

7. The computer implemented method according to claim 6, wherein the negative credit elements comprise at least one of collections, charge offs, bankruptcies, foreclosures and other public records.

8. The computer implemented method according to claim 6, wherein the positive credit elements comprise at least one of number of open tradelines, existing credit limit, and age of open tradelines.

9. The computer implemented method according to claim 1, wherein the waiting time comprises a time until the applicant will qualify for the loan and is computed by determining at least one of an amount of time until a credit score associated with the applicant is expected to exceed a threshold amount, an amount of time until an impact of at least one negative credit element on a credit score associated with the applicant is expected to below a threshold amount, and an amount of time until an impact of at least one positive credit element on a credit score associated with the applicant is expected to exceed a threshold amount.

10. The computer implemented method according to claim 1, wherein the applicant recommendations comprise guidance that would allow the applicant to qualify for a loan after the expected waiting time has lapsed or prior to the expected waiting time lapsing.

11. The computer implemented method according to claim 10, wherein the guidance comprises at least one of opening additional tradelines, making on time payments for a threshold period of time, paying off existing debt by an identified deadline, meeting or exceeding a threshold income amount, meeting or exceeding a threshold asset amount, and meeting or exceeding threshold employment criteria.

12. The computer implemented method according to claim 1, wherein the applicant recommendations are based on information obtained from a manual guidelines database.

13. The computer implemented method according to claim 1, wherein the applicant recommendations comprise alternative loan information wherein the alternative loan information is automatically computed and comprises at least one alternative loan for which the applicant would qualify at the current time or at a time prior to the expected waiting time.

14. The computer implemented method according to claim 13, wherein the alternative loan information comprises at least one of an alternative loan structure, loan amount, and loan program.

15. A system for providing users with real time access to loan qualification information, the system comprising:
control circuitry configured to perform a method comprising:
providing remote access to users over a network so any one of the users can initiate a loan qualification status check in real time through a graphical user interface;
obtaining, from an automated review system, loan qualification status information associated with an applicant, the automated review system associated with a hardware and/or software platform, the loan qualification status information indicating the applicant does not qualify for a loan;
automatically obtaining, from a universal residential loan application system and in response to the obtained loan qualification status information, loan application information associated with the applicant, the universal loan application system associated with a hardware and/or software platform;
automatically obtaining, from a credit report system and in response to the obtained loan qualification status information, credit information associated with the applicant, the credit system associated with a hardware and/or software platform;
wherein at least one of the loan qualification status information, loan application information and credit information is obtained in at least one of a standardized and non-standardized format based on the hardware and/or software platform associated with the corresponding system from which the information was obtained;
converting, by a processor, at least one of the loan qualification status information, loan application information, and credit information to a standardized format;
automatically computing, by a processor, at least one of an expected waiting time and applicant recommendations, the computing based on the standardized format of the loan qualification status information, loan application information, and credit information; and
providing at least one of the loan qualification status information in the standardized format, loan application information in the standardized format, credit information in the standardized format, expected waiting time and applicant recommendations, via remote access to users over a network, wherein each user is enabled to access up-to-date loan qualification information.

16. A non-transitory computer readable medium comprising instructions that, when executed by a processor, cause the processor to perform a method for providing users with real time access to loan qualification information, the method comprising:
providing remote access to users over a network so any one of the users can initiate a loan qualification status check in real time through a graphical user interface;
obtaining, from an automated review system, loan qualification status information associated with an applicant, the automated review system associated with a hardware and/or software platform, the loan qualification status information indicating the applicant does not qualify for a loan;
automatically obtaining, from a universal residential loan application system and in response to the obtained loan qualification status information, loan application information associated with the applicant, the universal loan application system associated with a hardware and/or software platform;
automatically obtaining, from a credit report system and in response to the obtained loan qualification status information, credit information associated with the applicant, the credit system associated with a hardware and/or software platform;
wherein at least one of the loan qualification status information, loan application information and credit information is obtained in at least one of a standardized and non-standardized format based on the hardware and/or software platform associated with the corresponding system from which the information was obtained;
converting, by a processor, at least one of the loan qualification status information, loan application information, and credit information to a standardized format;
automatically computing, by a processor, at least one of an expected waiting time and applicant recommendations, the computing based on the standardized format of the loan qualification status information, loan application information, and credit information; and
providing at least one of the loan qualification status information in the standardized format, loan application information in the standardized format, credit information in the standardized format, expected waiting time and applicant recommendations, via remote access to users over a network, wherein each user is enabled to access up-to-date loan qualification information.
